(19) United States
(12) Patent Application Publication
(10) Pub. No.: US 2021/0129989 A1
(43) Pub. Date: May 6, 2021

(54) UNMANNED AERIAL VEHICLES WITH STEREOSCOPIC IMAGING, AND ASSOCIATED SYSTEMS AND METHODS

(71) Applicant: PreNav, Inc., Redwood City, CA (US)

(72) Inventors: Nathan Schuett, Belmont, CA (US); Asa Hammond, Cotati, CA (US)

(21) Appl. No.: 17/061,009

(22) Filed: Oct. 1, 2020

Related U.S. Application Data
(63) Continuation of application No. PCT/US19/26558, filed on Apr. 9, 2019.
(60) Provisional application No. 62/655,109, filed on Apr. 9, 2018.

(51) Int. Cl. B64C 39/02; B64D 47/08; B64D 27/24; G03B 15/00; G03B 17/56; G03B 35/12

(52) U.S. Cl. CPC B64C 39/024; B64D 47/08; B64D 27/24; G03B 15/006; B64C 2201/127; G03B 35/12; B64C 2201/027; B64C 2201/042; B64C 2201/108; G03B 17/561

(57) ABSTRACT

Unmanned aerial vehicles (UAVs) with stereoscopic imaging, and associated systems and methods are disclosed herein. A representative system includes a support structure oriented relative to a vehicle roll axis, pitch axis, and yaw axis. The system further includes multiple propellers carried by the support structure, and first and second stereo imaging devices, also carried by the support structure. The first stereo imaging device has a first field of view, the second stereo imaging device has a second field of view, and at least one of the multiple propellers is positioned forward of and between the first and second stereo imaging devices. The at least one propeller has a rotation disc that does not overlap with the first and second fields of view. In representative configurations the fields of view also do not overlap with other (e.g., any other) structures of the UAV.

### CROSS-REFERENCE TO RELATED APPLICATION

The present application claims priority to pending U.S. Provisional Application No. 62/655,109, filed Apr. 9, 2018, and incorporated herein by reference.

### TECHNICAL FIELD

The present technology is directed generally to unmanned aerial vehicles with stereoscopic imaging, and associated systems and methods.

### BACKGROUND

Unmanned aerial vehicles (UAVs) have become increasingly popular devices for carrying out a wide variety of tasks that would otherwise be performed by manned aircraft or satellites. Such tasks include surveillance tasks, imaging tasks, and payload delivery tasks. However, existing UAVs have a number of drawbacks. For example, it can be difficult for UAVs to carry out tasks related to imaging terrain or structures to less than a few centimeters of resolution. Typical UAVs may have a camera for imaging, but struggle to resolve small dimensions, particularly when reconstructing an environment in 3-D. Another drawback associated with existing UAVs is that in many instances, the field of view of the imaging device carried by the UAV overlaps with the volume in which the propellers (which provide lift and thrust) operate. Accordingly, the images can include the propeller blades, or the airframe of the UAV, which can interfere with image processing. Therefore, there remains a need for techniques and associated systems that allow UAVs to safely, accurately, and in an uninterrupted manner, carry out operations in close proximity to elements in the surrounding environment.

### BRIEF DESCRIPTION OF THE DRAWINGS

FIG. 1 is a partially schematic, isometric illustration of an unmanned aerial vehicle (UAV) having imaging devices and propellers arranged in accordance with some embodiments of the present technology.

FIG. 2 is a partially schematic, isometric illustration of components of a representative UAV placed in a collapsed configuration, in accordance with some embodiments of the present technology.

FIG. 3 is another partially schematic illustration of a UAV having an arrangement generally similar to that shown in FIG. 1, in accordance with some embodiments of the present technology.

FIG. 4 is a partially schematic illustration of a UAV having imaging devices positioned behind multiple propellers in accordance with some embodiments of the present technology.

FIG. 5 is a partially schematic illustration of a UAV having imaging devices positioned behind multiple propellers in accordance with some embodiments of the present technology.

FIG. 6 is a partially schematic, isometric illustration of a UAV having imaging devices positioned behind multiple propellers in accordance with some embodiments of the present technology.

FIG. 7 is a partially schematic illustration of a UAV having an imaging device support member positioned in accordance with some embodiments of the present technology.

FIG. 8 is a partially schematic illustration of a UAV having a hexacopter configuration in accordance with some embodiments of the present technology.

FIG. 9 is a partially schematic illustration of a UAV having another hexacopter configuration in accordance with some embodiments of the present technology.

FIG. 10 is a partially schematic illustration of a UAV having an octocopter configuration in accordance with some embodiments of the present technology.

### DETAILED DESCRIPTION

The present technology is directed generally to unmanned aerial vehicles (UAVs) with stereoscopic imaging capabilities, and associated systems and methods. For example, in some embodiments, the UAV includes a multi-copter configuration having multiple propeller blades, and a stereoscopic imaging system positioned behind at least one of the propellers. Positioning the imaging system behind or aft of least one of the propellers can reduce or eliminate the pitching moments induced by the imaging system. The stereoscopic imaging system can include multiple imaging devices (i.e., two or more) that are spaced apart far enough from each other to provide accurate, stereoscopic images with a resolution on the order of millimeters. At the same time, the imaging devices can be spaced far apart enough from the forward-located propeller such that the fields of view of the imaging devices do not overlap with the motion path of the propeller, thus avoiding capturing the propeller in the resulting images.

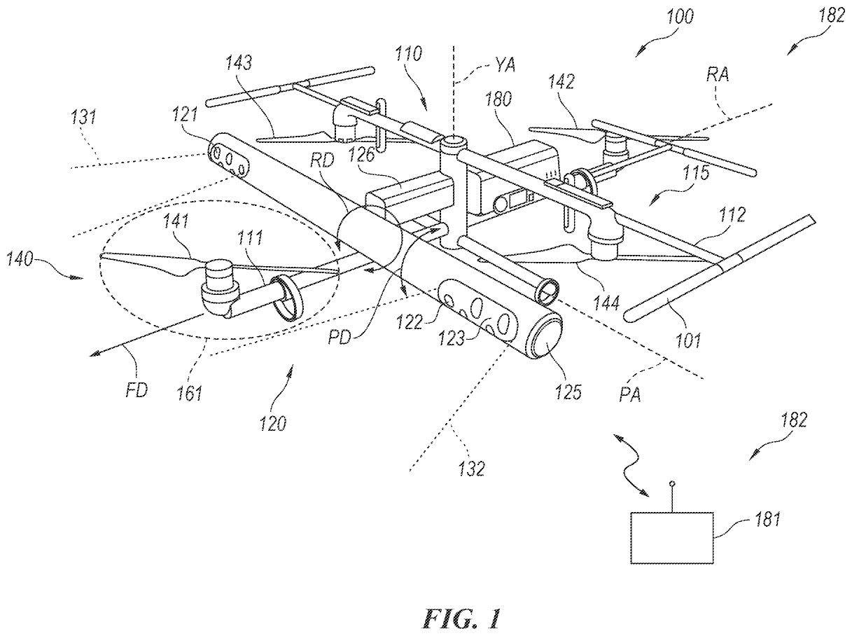

Specific details of some embodiments of the disclosed technology are described below with reference to particular, representative configurations. The disclosed technology may be practiced in accordance with UAVs and associated systems having other configurations. Specific details describing structures or processes that are well-known and often associated with UAVs, but that may unnecessarily obscure some significant aspects of the presently disclosed technology, are not set forth in the following description for purposes of clarity. Moreover, although the following disclosure sets forth some embodiments of different aspects of the disclosed technology, some embodiments of the technology can have configurations and/or components different than those described in this section. As such, the present technology may include some embodiments with additional elements and/or without several of the elements described below with reference to FIGS. 1-10.

Several embodiments of the disclosed technology may take the form of computer-executable instructions, including routines executed by a programmable computer or controller. Those skilled in the relevant art will appreciate that the technology can be practiced on computer or controller systems other than those shown and described below. The technology can be embodied in a special-purpose computer, controller, or data processor that is specifically programmed, configured, or constructed to perform one or more of the computer-executable instructions described below. Accordingly, the terms “computer” and “controller” as generally used herein include a suitable data processor (airborne and/or ground-based) and can include internet appliances and hand-held devices, including palm-top computers, wearable computers, cellular or mobile phones, multi-processor systems, processor-based programmable consumer electronics, network computers, laptop computers, mini-computers, and the like. Information handled by these computers can be presented at any suitable display medium, including a liquid crystal display (LCD). As is known in the art, these computers and controllers commonly have various processors, memories (e.g., non-transitory computer-readable media), input/output devices, and/or other suitable features.

The present technology can also be practiced in distributed environments, where tasks or modules are performed by remote processing devices that are linked through a communications network. In a distributed computing environment, program modules or subroutines may be located in local and/or remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the present technology.

FIG. 1 is a partially schematic, isometric illustration of a representative UAV 100 configured in accordance with embodiments of the present technology. The UAV 100 can include a support structure 110 that carries a propulsion system 140 and an imaging system 120. The imaging system 120 can include multiple optical devices, for example, imaging devices, and the propulsion system 140 can include multiple propellers, all of which can be controlled via a controller 182. The controller 182 can include an on-board control module 180 and/or an off-board control module 181. The on-board control module 180 can operate autonomously, and/or with input provided by the off-board control module 181. In a representative configuration, the UAV 100 includes one or more light bars 101 or other devices to aid in orienting the UAV and/or lighting its environment.

The UAV 100 can be maneuvered relative to multiple axes, including a roll axis RA, a pitch axis PA, and a yaw axis YA. The roll axis RA is generally aligned with a forward travel direction FD of the UAV 100. The propulsion system 140 can include multiple propellers, for example, four propellers, illustrated in FIG. 1 as a first propeller 141, a second propeller 142, a third propeller 143, and a fourth propeller 144. The propellers can be carried by corresponding propeller support members 115. Accordingly, the first and second propellers 141, 142 can be carried by a first propeller support member 111, and the third and fourth propellers 143, 144 can be carried by a second propeller support member 112. The propeller support members 111, 112 can be oriented transverse to each other, for example, in an “X” configuration (non-orthogonal) or, as shown in FIG. 1, a “cross” configuration (orthogonal). By selectively adjusting the rotation rates (and, optionally, blade pitch angle) of the propellers, the UAV can be directed along and/or rotated relative to, any of the pitch, roll, and yaw axes. The first and second propellers 141, 142 can face upwardly, and the third and fourth propellers 143, 144 can face downwardly, or the propellers can have other suitable orientations. An advantage of the propeller orientation shown in FIG. 1 is that all the propellers can be in generally the same plane (which simplifies vehicle control), despite the vertical offset between the first and second support members 111, 112.

The imaging system 120 can include an optical device support 125 that is carried by, and movable relative to, the support structure 110. In some embodiments, the optical device support 125 carries imaging devices. The optical device support 125 may be referred to herein as an imaging device support, but may support optical devices other than imaging devices. In a representative embodiment, the optical or imaging device support 125 is coupled to a gimbal support 126 via a gimbal joint that allows a range of motion in a pitch direction PD (e.g., about an axis co-linear with or parallel to the pitch axis PA) and a roll direction RD (e.g., about an axis co-linear with or parallel to the roll axis RA). The motion of the optical or imaging device support 125 in the pitch direction PD can be limited by the range of the gimbal joint between (a) the imaging device support 125 and (b) the gimbal structure 126 (or another element of the UAV 100 to which the imaging device support 125 is connected). The range of motion in the roll direction RD can be limited by the location of the first propeller support member 111. The optical or imaging device support 125 may have no yaw rotation capability, which is instead provided by yawing the UAV 100.

The optical or imaging device support 125 carries one or more optical devices, e.g., imaging devices, for example, a first imaging device 121, and a second imaging device 122. Each of the imaging devices 121, 122 can have an aperture 123 through which the imaging device accesses the surrounding environment. Accordingly, each imaging device 121, 122 has a corresponding field of view 131, 132. The two fields of view 131, 132 overlap at a distance forward of the imaging devices 121, 122, to provide for stereoscopic imaging. More particularly, due to the lateral offset between the two imaging devices 121, 122, the images taken by each imaging device 121, 122 at a given point in time are slightly different. This difference can be used to provide depth to the combined image. The imaging devices 121, 122 can capture still and/or video images in the visible spectrum and/or another spectrum, e.g., the infrared and/or ultraviolet spectra.

As shown in FIG. 1, the first propeller 141 circumscribes and occupies a first propeller disc 161 when it rotates. As is also shown in FIG. 1, the two fields of view 131, 132 of the corresponding imaging devices 121, 122 do not overlap with the first propeller disc 161, and overlap with each other only in a region (not visible in FIG. 1) forward of the first propeller disc 161. As a result, the first and second imaging devices 121, 122 can provide an effective stereoscopic image, without the image having the first propeller 141 included in it. The UAV 100 can also be configured such that the two fields of view 131, 132 do not overlap with any other elements of the UAV 100, e.g., the support structure 110, other elements of the propulsion system 140, the control module 180, the gimbal module 126, and other optical or non-optical devices. The fixed (or otherwise known) spacing between the first and second imaging devices 121, 122 allows for accurate stereoscopic image generation without being so great as to significantly increase the moment of inertia of the UAV 100 about the yaw axis YA and/or the roll axis RA. Accordingly, the UAV 100 can still be controlled and maneuvered in a fast, effective manner. Furthermore, the imaging device support 125 and the first and second imaging devices 121, 122 can be positioned relatively close to the aircraft center of gravity, which may be at or near the point at which the first and second propeller support members 111, 112 cross. This in turn can eliminate the need for ballast to balance the weight of the imaging device support 125 and the imaging devices 121, 122. This approach in turn reduces overall vehicle weight and, as discussed above, reduces the impact of the imaging devices 121, 122 and imaging device support 125 on the control and stability of the UAV 100.

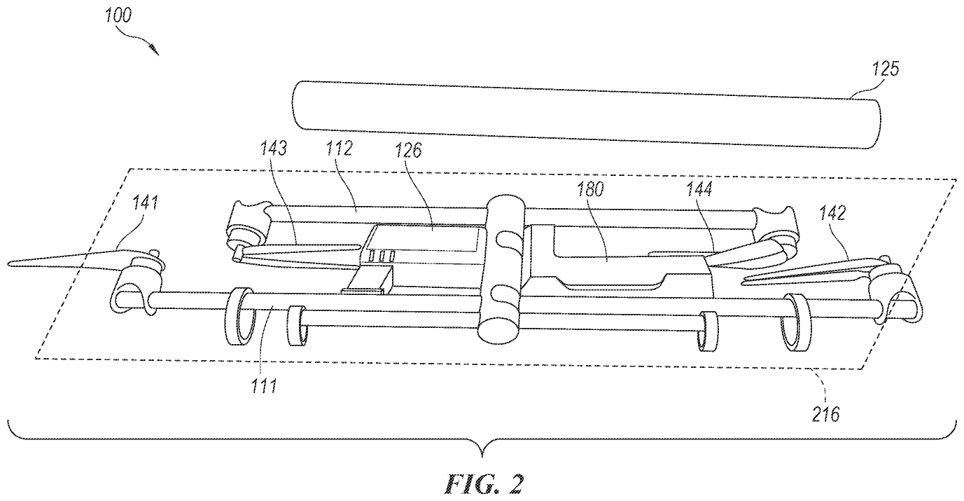

In some embodiments, the UAV 100 can be specifically arranged to be placed in a compact, stowed configuration when not in use. For example, referring now to FIG. 2, the UAV 100 can be folded so that the first propeller support member 111 and the second propeller support member 112 are in generally the same plane (e.g., a stowed plane 216). The propellers can also be folded so as to fit generally into the stowed plane 216. For example, as shown in FIG. 2, the first, second, third, and fourth propellers 141, 142, 143, 144 have all been folded to fit generally within the stowed plane 216. To deploy the UAV 100, the first and second propeller support members 111, 112 are rotated relative to each other into the deployed configuration shown in FIG. 1, the imaging device support 125 is attached and electrically connected to the control module 180, and the propellers are unfolded for flight.

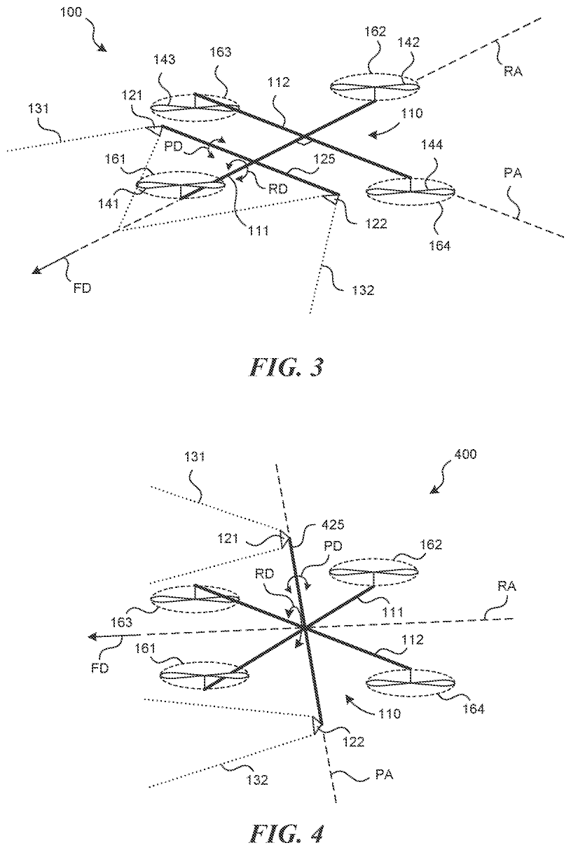

FIG. 3 is a more schematized illustration of the UAV 100, illustrating the first propeller 141 and the corresponding first propeller disc 161, as well as propeller discs 162, 163, 164 for each of the second, third, and fourth propellers 142, 143, 144, respectively. FIG. 3 schematically illustrates the first and second fields of view 131, 132, which converge with each other forward of the first propeller disc 161 and do not overlap with the first propeller disc 161. The lack of an overlap applies throughout the pitch direction PD range of the imaging support device 125 and the roll direction RD range of the imaging support device 125. A representative pitch direction range is 300°, and a representative roll direction range is 90°. For purposes of clarity, the gimbal support 126, control module 180, and other details of the UAV shown in FIG. 1 are not shown in FIG. 3.

FIGS. 4-10 schematically illustrate configurations in accordance with some embodiments of the present technology that also include stereoscopic imaging devices positioned behind (aft of) one or more propellers, in a manner that does not create an overlap between the rotational discs of the corresponding propellers and the fields of view of the imaging devices. FIGS. 4-10 are schematized in the manner of FIG. 3 so as to more clearly illustrate features that differ among the configurations. In at least some of the Figures, the orientation of UAV may make it appear as though the imaging device fields of view overlap with the forward rotational disc; however, this is simply due to the angle from which the UAV is viewed. The schematized illustrations of FIGS. 4-10 are presented for ease of illustration. Any of the embodiments shown in these Figures can have overall configurations similar to those shown in FIGS. 1 and 2, though with different propeller and/or camera configurations.

Beginning with FIG. 4, a representative UAV 400 includes a support structure 110 with the corresponding first and second propeller supports 111, 112 arranged in a “X” configuration. Accordingly, the roll axis RA is aligned with the forward direction FD of flight, but is not aligned with either the first propeller support 111 or the second propeller support 112. The corresponding imaging device support 425 is arranged transverse to the roll axis RA so as to rotate in the roll direction RD (about an axis co-linear with or parallel to the roll axis RA), and rotate in a pitch direction PD (about an axis co-linear with or parallel to the pitch axis PA). This arrangement places both the first rotational disc 161 and the third rotational disc 163 forward of the first and second imaging devices 121, 122, and the imaging device support 425. Accordingly, the first and second imaging devices 121, 122 may be placed further away from the roll axis RA along the imaging device support 425 than in the configurations shown in FIGS. 1 and 3, so as to avoid an overlap between the corresponding fields of view 131, 132 and the rotational discs 161, 163. An advantage of this arrangement is that the greater distance between the first and second imaging devices 121, 122 can increase the fidelity of the resulting stereoscopic image. A potential drawback with this arrangement is that the imaging device support 425 is longer, which increases its weight, and increases the moment of inertia created by it and the first and second imaging devices 121, 122. The increased moment of inertia can slow the response time and/or remove maneuver characteristics of the UAV 400. However, depending on the particular use scenario, the increased stereoscopic fidelity can more than offset the slower response time.

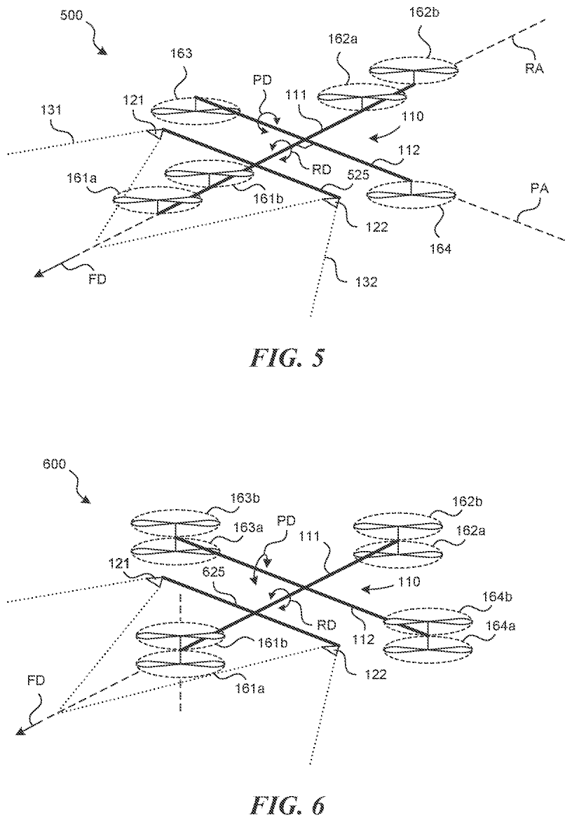

FIG. 5 is a schematic illustration of a UAV 500 that includes multiple propellers and corresponding rotational discs positioned forward of the first and second imaging devices 121, 122, but arranged along an axis aligned with the roll axis RA. In particular, the UAV 500 can include two first propellers and corresponding rotational discs 161a, 161b and, for thrust and weight balance, two second propellers and rotational discs 162a, 162b. The first and second imaging devices 121, 122 are positioned so that the respective first and second fields of view 131, 132 do not overlap with either of the two first rotational discs 161a, 161b.

FIG. 6 illustrates a representative UAV 600 having a dual quadcopter configuration in accordance with representative embodiments of the present technology. Accordingly, the UAV 600 includes propellers circumscribing two coaxial first rotational discs 161a, 161b, two coaxial second rotational discs 162a, 162b, two coaxial third rotational discs 163a, 163b, and two coaxial fourth rotational discs 164a, 164b. The corresponding imaging device support 625 can have a configuration generally similar to that discussed above with reference to FIGS. 1 and 3, with the spacing between the imaging devices 121, 122 and/or the ranges of motion in the pitch direction PD and/or the roll direction RD adjusted to account for the increased volume carved out by the combined two first rotational discs 161a, 161b.

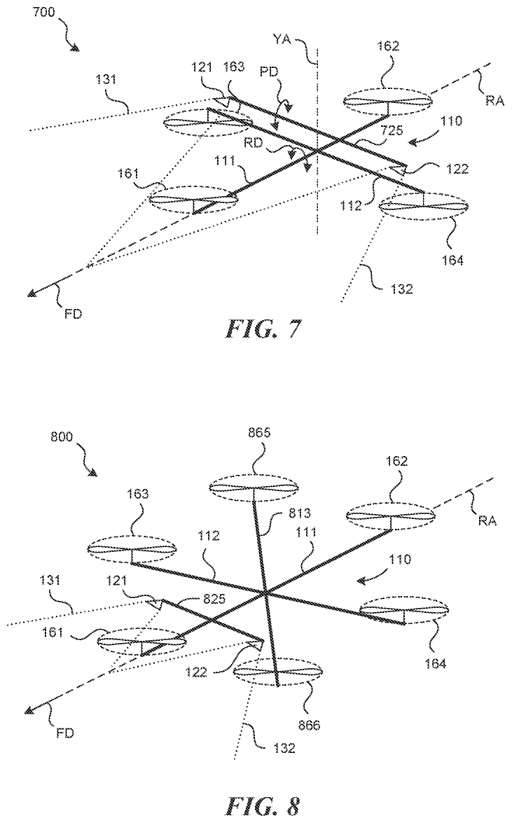

FIG. 7 is a schematic illustration of a representative UAV 700 in which the imaging device support 725 is positioned directly over the second propeller support 112 along the yaw axis YA. Accordingly, three propellers and corresponding rotational discs are positioned, at least in part, forward of the first imaging device 121 and the second imaging device 122. The three rotational discs include the first rotational disc 161, the third rotational disc 163, and the fourth rotational disc 164. An advantage of this arrangement is that the imaging device support 725 may be located closer to the UAV center of gravity than in the arrangement shown in FIGS. 1 and 3. A potential drawback with this arrangement is that the motion of the imaging device support 725 in the roll direction RD may be limited by the second propeller support 112. The motion of the imaging device support 725 in the pitch direction PD may also be limited so as to avoid an overlap between the first and second fields of view 131, 132 and the third and fourth rotational discs 163, 164, as well as the second propeller support 112. This potential drawback can be alleviated by positioning the first imaging device 121 so that the first field of view 131 extends between the third rotational disc 163 and the first rotational disc 161, without overlapping with either, and positioning the second imaging device 122 such that the second field of view 132 is positioned between the first rotational disc 161 and the fourth rotational disc 164, again, without overlapping with either; however the overlap with the second propeller support 112 may still be present.

FIG. 8 schematically illustrates another representative UAV 800 having a hexacopter configuration. Accordingly, in addition to features generally similar to those described above with reference to FIGS. 1 and 3, the UAV 800 can include a third propeller support 813 carrying propellers that circumscribe a fifth rotational disc 865 and a sixth rotational disc 866. In an aspect of this embodiment, the first propeller support 111 is oriented along the roll axis RA, and the second and third propeller supports 112, 813 are positioned at acute angles relative to the first propeller support 111 to form a uniform, symmetric hexagonal shape with 60° angles between neighboring propeller support segments. In other configurations, these angles can differ. In general, the corresponding imaging device support 825 can be positioned transverse to the roll axis RA, and can carry the first and second imaging devices 121, 122 such that the corresponding first and second fields of view 131, 132 do not overlap with the first rotational disc 161, the third rotational disk 163, or the sixth rotational disk 866.

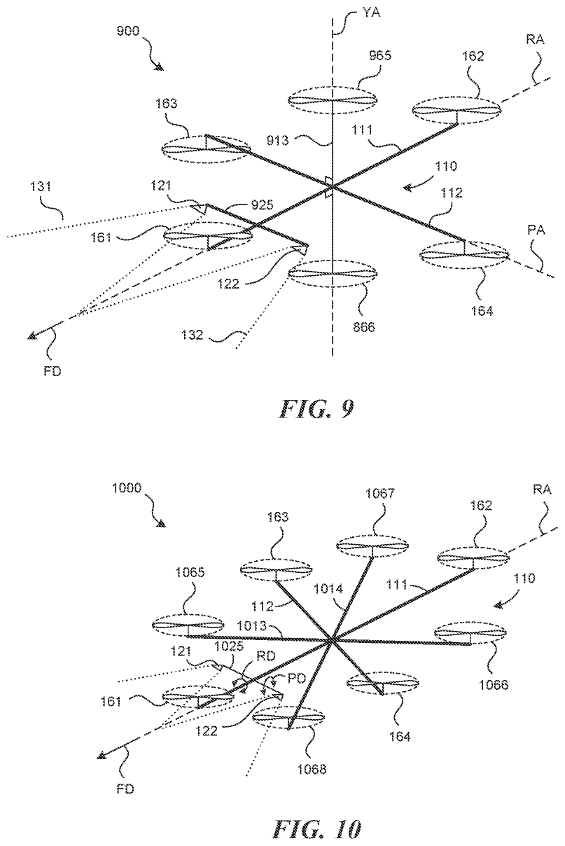

FIG. 9 illustrates a UAV 900 having a hexagonal configuration in accordance with embodiments of the present technology, in which a third propeller support 913 is aligned along the yaw axis YA, with corresponding propellers producing fifth and sixth rotational discs 965, 966 that are transverse to (e.g., perpendicular to) the yaw axis YA. The corresponding imaging support device 925 can carry the first and second imaging devices 121, 122 in the manner shown in FIG. 9, generally similarly to the manner described above with reference to FIGS. 1 and 3, with accommodations made depending upon the relative size of the first rotational disc 161. In particular, the first rotational disc 161 may be smaller than the first rotational disc 161 shown in FIG. 3 (e.g., due to the addition of the propellers producing the fifth and sixth rotational discs 965, 966), which can increase the first and second fields of view 131, 132 and/or decrease the spacing between the first and second imaging devices 121, 122.

FIG. 10 is a schematic illustration of a UAV 1000 having an octocopter configuration in accordance with some embodiments of the present technology. Accordingly, the support structure 110 can include first and second propeller supports 111, 112 having a cross configuration, as well as third and fourth propeller supports 1013, 1014, also arranged in a cross configuration and offset (e.g., by 45° degrees) from the cross configuration produced by the first and second propeller supports 111, 112. The resulting rotational discs include the first-fourth rotational discs 161-164, as well as fifth-eighth rotational discs and 1065-1068. The corresponding imaging device support 1025 can be positioned transverse to the roll axis RA as shown in FIG. 10, with the corresponding imaging device fields of view 131, 132 positioned so as not to overlap with the first rotational disc 161, the fifth rotational disk 1065, or the eighth rotational disk 1068.

As described above, one feature of some embodiments described herein is that at least one pair of stereoscopic imaging devices can be positioned behind at least one propeller. An advantage of this arrangement is that the imaging devices can be located closer to the UAV center of gravity, without having the propeller impinge on the images captured by the imaging devices. In particular, the position of the imaging devices forward of one or more aft propellers reduces or eliminates the likelihood for those propellers to impinge on the captured images. At the same time, the spacing between the stereoscopic imaging devices can allow the fields of view of the imaging devices to overlap (thus facilitating stereoscopic imaging), but only forward of the remaining forward propeller or propellers. In any of these embodiments, the fidelity and depth resolution provided by the stereoscopic imaging devices can allow the UAV to precisely locate itself relative to objects in its environment. This can be particularly useful for inspecting wind turbines, high voltage electrical towers, cell phone towers, and/or other equipment, with sufficient precision to accurately identify (and in some applications, correct) defects, damage, and/or other issues that may be of small scale, but nevertheless can have a significant adverse effect on the performance of the inspected device.

Another feature of several of the representative configurations described above is that the stereoscopic imaging devices can have a wide range of motion, and in particular, can provide stereoscopic images looking forward, looking upward, and looking downward, all without interference from the propellers. This is unlike typical existing configurations, which are unable to produce such a wide range of imaging angles, and/or produce images that are interfered with by the propellers of the UAV, and/or fail to produce stereoscopic images.

As described above, several of the foregoing configurations can produce high resolution images. In addition, such images can be produced without requiring that the UAV approach so close to the imaged device that it risks a collision. In particular embodiments, the fixed position and the distance between paired stereoscopic imaging devices can result in resolving features of 200 microns, from a distance of three to five meters away. In a representative configuration, the propellers have a diameter of 17 inches, the first and second imaging devices are spaced apart by 32.5 inches, and the imaging device support is positioned 12 inches forward of the second propeller support members. The foregoing dimensions can be adjusted for different vehicle sizes, shapes, configurations and/or missions.

From the foregoing, it will be appreciated that specific embodiments of the disclosed technology have been described herein for purposes of illustration, but that various modifications may be made without deviating from the technology. For example, the optical devices can include imaging devices, and or other optical devices that may facilitate image gathering (or other tasks) and that benefit from a clear field of view. Representative devices include range finders, projectors and/or active illuminators. In some embodiments, the propellers may be electrically-driven, or driven by other engine or motor types. The UAV can include numbers of propellers other than those expressly shown and described herein (e.g., 12, 16, 32 and/or other numbers of propellers) for which the propeller discs do not overlap with the relevant fields of view of the optical devices carried by the UAV.

The imaging support member (which can support any suitable type of optical device, not just an imaging device) can be connected to the gimbal support 126 as shown in FIG. 1, or can be connected to any element of the UAV, including any element of the support structure 110. In several of the configurations described above, the imaging device support is pivotable relative to the UAV. In some configurations, e.g., limited field of view, high precision configurations, the imaging device support can be fixed. In some embodiments, the imaging device support is not pivotable relative to the UAV about any axis colinear with, or parallel to, the yaw axis. In other embodiments, the imaging device support can rotate in a yaw direction. In other embodiments, the imaging device support can rotate about different axes or combinations of axes. The imaging devices can produce any of a number of suitable image types, and can measure any of a number of suitable characteristics of the environments in which they operate and/or the objects they image. In several of the illustrated configurations, the imaging devices support carries a single pair of imaging devices. In other representative configurations, each imaging device can be replaced with a set of multiple imaging devices. In other representative configurations, the UAV can carry multiple imaging device supports.

Certain aspects of the technology described in the context of particular embodiments may be combined or eliminated in other embodiments. For example, any of the configurations can include other devices (e.g., grippers or manipulation tools) in addition to the elements described above. Any of the configurations can include or eliminate the light bars shown in FIG. 1. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the disclosure and associated technology can encompass other embodiments not expressly shown or described herein.

As used herein, the phrase “and/or” as in “A and/or B” refers to A alone, B alone and A and B. To the extent any materials incorporated herein by reference conflict with the present disclosure, the present disclosure controls.

Representative examples of the present technology are described further below.

### EXAMPLES

1. An unmanned aerial vehicle, comprising:
a first propeller support member elongated along a vehicle roll axis and carrying first and second spaced-apart propellers;
a second propeller support member elongated along a vehicle pitch axis and attached to the first elongated propeller support member between the first and second propellers in a cross configuration, the second propeller support member carrying third and fourth spaced-apart propellers;
a gimbal support carried by at least one of the elongated propeller support members;
a camera support elongated between a first end and a second end, the camera support being positioned aft of the first propeller and forward of the second, third, and fourth propellers, the camera support being coupled to the gimbal support and being pivotable relative to the gimbal support in a pitch direction and a roll direction, the camera support carrying:
   a first camera having a first field of view and positioned toward the first end; and
   a second camera having a second field of view and positioned toward the second end, with the first propeller positioned forward of and between the first and second cameras, and having a rotation disc that does not overlap with the first and second fields of view.

2. The system of clause 1 wherein the camera support is removable from the gimbal support, and wherein the first support member, the second support member, and the gimbal support are pivotably coupled and movable between:
a stowed configuration in which the first support member, the second support member, and the gimbal support are positioned in a common plane; and
a deployed configuration in which the second support member is positioned transverse to the first support member and the gimbal support.

3. The system of any of clauses 1-2 wherein the first camera is one of multiple cameras positioned toward the first end of the camera support.

4. An unmanned aerial vehicle system, comprising:
a support structure oriented relative to a vehicle roll axis, pitch axis and yaw axis;
multiple propellers carried by the support structure; and
first and second optical devices carried by the support structure, the first optical device having a first field of view, the second optical device having a second field of view, with at least one of the multiple propellers positioned forward of and between the first and second optical devices, and having a rotation disc that does not overlap with the first and second fields of view.

5. The system of clause 4 wherein the first and second optical devices are pivotable relative to the support structure.

6. The system of clause 4 wherein the first and second optical devices are fixed relative to the support structure.

7. The system of any of clauses 4-6 wherein the support structure includes a first propeller support member carrying a first plurality of propellers and second propeller support member carrying a second plurality of support members, and wherein the first and second propeller support members overlap.

8. The system of clause 7 wherein the first and second propeller support members form a cross.

9. The system of any of clauses 4-8 wherein only a single propeller is positioned forward of and between the first and second optical devices.

10. The system of any of clauses 4-9 wherein the first and second optical devices are not pivotable about any axis parallel to the yaw axis.

11. The system of any of clauses 4-10 wherein the at least one propeller is rotatable relative to the support structure about a rotation axis, and wherein the rotation axis is positioned forward of the first and second optical devices.

12. The system of clause 11 wherein the rotation axis is positioned forward of a first aperture of the first optical device and a second aperture of the second optical device.

13. The system of any of clauses 4-12, further comprising a control module carried by the support structure and operatively coupled to the multiple propellers to control the multiple propellers.

14. The system of any of clauses 4-13, except clause 6 wherein the first and second optical devices are pivotable relative to the support structure in a pitch direction and a roll direction.

15. The system of any of clauses 4-14 wherein the first and second optical devices are carried by an imaging device support, and wherein the imaging device support is pivotable relative to the support structure in a pitch direction and a roll direction.

16. The system of any of clauses 4-15 wherein the first and second imaging devices include first and second cameras.

17. The system of clause 16 wherein the first and second cameras operate in the visible spectrum.

18. The system of clause 16 wherein the first and second cameras operate in the infrared spectrum.

19. The system of any of clauses 4-18 wherein the propellers are arranged in a quadcopter configuration.

20. The system of clause 19 wherein the propellers are positioned in a common plane and are connected to corresponding motors, and wherein two of the motors have an inverted orientation relative to the remaining two motors.

21. The system of any of clauses 4-18 wherein the propellers are arranged in a hexacopter configuration.

22. The system of any of clauses 4-18 wherein the propellers are arranged in a octocopter configuration.

23. The system of any of clauses 4-22 wherein the stereo imaging devices are coupled to a processor to produce a stereo image.

24. The system of clause 23 wherein the processor is carried by the support structure.

25. The system of clause 23 wherein the processor is offboard the support structure.

26. The system of any of clauses 4-25 except clause 6 wherein the first and second optical devices are rotatable to direct the first and second fields of view downwardly relative to a plane that includes the pitch and roll axes.

27. The system of any of clauses 4-26 wherein the first and/or second optical devices include rangefinders, projectors, and/or active illuminators.

28. The system of any of clauses 4-27 wherein the first optical device is one of multiple cameras toward the right side of the support structure, and wherein the second optical device is one of multiple cameras toward the left side of the support structure.

29. An unmanned aerial vehicle system, comprising:
a support structure oriented relative to a vehicle roll axis, pitch axis and yaw axis;
multiple propellers carried by the support structure;
first and second optical devices carried by the support structure, the first optical device having a first field of view and a first motion range, the second optical device having a second field of view and a second motion range, with at least one of the multiple propellers having a rotation disc and being positioned forward of and between the first and second optical devices;
a controller programmed with instructions that, when executed:
   receive an input corresponding to a requested optical device orientation;
   in response to the input:
      direct the first optical device to any possible position in the first motion range without the first field of view overlapping with the rotation disc; and
      direct the second optical device to any possible position in the second motion range without the second field of view overlapping with the rotation disc.

30. The system of clause 29 wherein the support structure includes a first propeller support member carrying a first plurality of propellers and second propeller support member carrying a second plurality of support members, and wherein the first and second propeller support members overlap.

31. The system of any of clauses 29-30 wherein the first and second optical devices are not pivotable about any axis parallel to the yaw axis.

32. The system of any of clauses 29-31 wherein the first and second optical devices are carried by an imaging device support, and wherein the imaging device support is pivotable relative to the support structure in a pitch direction and a roll direction.

I/We claim:

1. An unmanned aerial vehicle, comprising:
a first propeller support member elongated along a vehicle roll axis and carrying first and second spaced-apart propellers;
a second propeller support member elongated along a vehicle pitch axis and attached to the first elongated propeller support member between the first and second propellers in a cross configuration, the second propeller support member carrying third and fourth spaced-apart propellers;
a gimbal support carried by at least one of the elongated propeller support members;
a camera support elongated between a first end and a second end, the camera support being positioned aft of the first propeller and forward of the second, third, and fourth propellers, the camera support being coupled to the gimbal support and being pivotable relative to the gimbal support in a pitch direction and a roll direction, the camera support carrying:
a first camera having a first field of view and positioned toward the first end; and
a second camera having a second field of view and positioned toward the second end, with the first propeller positioned forward of and between the first and second cameras, and having a rotation disc that does not overlap with the first and second fields of view.

2. The system of claim 1 wherein the camera support is removable from the gimbal support, and wherein the first support member, the second support member, and the gimbal support are pivotably coupled and movable between:
a stowed configuration in which the first support member, the second support member, and the gimbal support are positioned in a common plane; and
a deployed configuration in which the second support member is positioned transverse to the first support member and the gimbal support.

3. The system of claim 1 wherein the first camera is one of multiple cameras positioned toward the first end of the camera support.

4. An unmanned aerial vehicle system, comprising:
a support structure oriented relative to a vehicle roll axis, pitch axis and yaw axis;
multiple propellers carried by the support structure; and
first and second optical devices carried by the support structure, the first optical device having a first field of view, the second optical device having a second field of view, with at least one of the multiple propellers positioned forward of and between the first and second optical devices, and having a rotation disc that does not overlap with the first and second fields of view.

5. The system of claim 4 wherein the first and second optical devices are pivotable relative to the support structure.

6. The system of claim 4 wherein the first and second optical devices are fixed relative to the support structure.

7. The system of claim 4 wherein the support structure includes a first propeller support member carrying a first plurality of propellers and second propeller support member carrying a second plurality of support members, and wherein the first and second propeller support members overlap.

8. The system of claim 7 wherein the first and second propeller support members form a cross.

9. The system of claim 4 wherein only a single propeller is positioned forward of and between the first and second optical devices.

10. The system of claim 4 wherein the first and second optical devices are not pivotable about any axis parallel to the yaw axis.

11. The system of claim 4 wherein the at least one propeller is rotatable relative to the support structure about a rotation axis, and wherein the rotation axis is positioned forward of the first and second optical devices.

12. The system of claim 11 wherein the rotation axis is positioned forward of a first aperture of the first optical device and a second aperture of the second optical device.

13. The system of claim 4, further comprising a control module carried by the support structure and operatively coupled to the multiple propellers to control the multiple propellers.

14. The system of claim 4 wherein the first and second optical devices are pivotable relative to the support structure in a pitch direction and a roll direction.

15. The system of claim 4 wherein the first and second optical devices are carried by an imaging device support, and wherein the imaging device support is pivotable relative to the support structure in a pitch direction and a roll direction.

16. The system of claim 4 wherein the first and second imaging devices include first and second cameras.

17. The system of claim 16 wherein the first and second cameras operate in the visible spectrum.

18. The system of claim 16 wherein the first and second cameras operate in the infrared spectrum.

19. The system of claim 4 wherein the propellers are arranged in a quadcopter configuration.

20. The system of claim 19 wherein the propellers are positioned in a common plane and are connected to corresponding motors, and wherein two of the motors have an inverted orientation relative to the remaining two motors.

21. The system of claim 4 wherein the propellers are arranged in a hexacopter configuration.

22. The system of claim 4 wherein the propellers are arranged in a octocopter configuration.

23. The system of claim 4 wherein the stereo imaging devices are coupled to a processor to produce a stereo image.

24. The system of claim 23 wherein the processor is carried by the support structure.

25. The system of claim 23 wherein the processor is offboard the support structure.

26. The system of claim 4 wherein the first and second optical devices are rotatable to direct the first and second fields of view downwardly relative to a plane that includes the pitch and roll axes.

27. The system of claim 4 wherein the first and/or second optical devices include rangefinders, projectors, and/or active illuminators.

28. The system of claim 4 wherein the first optical device is one of multiple cameras toward the right side of the support structure, and wherein the second optical device is one of multiple cameras toward the left side of the support structure.

29. An unmanned aerial vehicle system, comprising:
a support structure oriented relative to a vehicle roll axis, pitch axis and yaw axis;
multiple propellers carried by the support structure;
first and second optical devices carried by the support structure, the first optical device having a first field of view and a first motion range, the second optical device having a second field of view and a second motion range, with at least one of the multiple propellers having a rotation disc and being positioned forward of and between the first and second optical devices; and
a controller programmed with instructions that, when executed:
receive an input corresponding to a requested optical device orientation; and
in response to the input:
direct the first optical device to any possible position in the first motion range without the first field of view overlapping with the rotation disc; and
direct the second optical device to any possible position in the second motion range without the second field of view overlapping with the rotation disc.

30. The system of claim 29 wherein the support structure includes a first propeller support member carrying a first plurality of propellers and second propeller support member carrying a second plurality of support members, and wherein the first and second propeller support members overlap.

31. The system of claim 29 wherein the first and second optical devices are not pivotable about any axis parallel to the yaw axis.

32. The system of claim 29 wherein the first and second optical devices are carried by an imaging device support, and wherein the imaging device support is pivotable relative to the support structure in a pitch direction and a roll direction.
